(19) United States
(12) Patent Application Publication
(10) Pub. No.: US 2005/0111311 A1
(43) Pub. Date: May 26, 2005

(54) Optical pickup

(75) Inventor: Hideaki Funakoshi, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 10/956,372

(22) Filed: Oct. 4, 2004

(30) Foreign Application Priority Data
Oct. 8, 2003 (JP) P. 2003-348945

(51) Int. Cl. G11B 7/00

(52) U.S. Cl. 369/44.15; 369/44.22

(57) ABSTRACT

An optical pickup is provided with a substrate on which a plurality of through holes are formed, wires whose base end sides are inserted through the through hole of the substrate, a lens holder supported on the front end sides of the wires, and a retaining member provided between the substrate and lens holder. The retaining member has laterally opened concave portions for filling a cushioning material and notch portions to communicate with these concave portions. The wires are disposed so as to be stored in the concave portions and are, at a lens holder-side surface of the substrate, soldered to the substrate.

### BACKGROUND OF THE INVENTION

1. Field of the Invention

The present invention relates to an optical pickup for recording and reproducing information with respect to an optical disk such as a CD or a DVD.

2. Description of the Related Art

FIG. 10 is a side sectional view showing a schematic construction of a conventional optical pickup. In the drawing, 50 denotes an optical pickup used for a DVD player or the like, which is provided with a substrate 51, a plurality of wires 52, a retaining member 53, and a lens holder 54. On the substrate 51, a plurality of through holes 51a are formed, and through these through holes 51a, the base end sides of the wires 52 are inserted. These wires 52 are made of resilient metal materials and are fixed to the substrate 51 by being soldered at a surface 51b of the substrate 51 on the side opposite the lens holder 54. 56 denotes this soldering portion.

In the retaining member 53, a cushioning material 57 made of viscoelastic media (gel agent) for absorbing vibration of the wires 52 is filled, and the wires 52 penetrate through this cushioning material 57. Here, the retaining material 53 is fixed by an appropriate means integrally with the substrate 51.

On the top surface of the lens holder 54, an object lens 58 is held, and the front end sides of the wires 52 are engaged with a convex portion 54a formed on the side surface. In addition, on the side surface of the lens holder 4, a plurality of pins 54b are provided in proximity to the wires 52. Around these pins 54b, one-end portions of drive coils 55 for driving the lens holder 54 are wound, and each coil 55 is electrically connected to the wire 52 by a means such as soldering. The respective coils 55 are for shifting the lens holder 54 in a focusing direction (up and down), a tracking direction (right and left), and a tilt direction (diagonally), which shifts, by utilizing a Lorentz force acting between magnetic fields generated by a power distribution to the coils and magnetic fields of magnets (unillustrated), the lens holder 54 in each direction as described above. Vibration produced by the wires 52 during this shifting is absorbed by the cushioning material 57 made of viscoelastic media.

As prior arts related to an optical pickup structured so as to support a lens holder on a substrate via a plurality of wires, for example, Japanese Patent No. 2860964, Japanese Patent No. 3137324 and JP-A-2001-344783.

However, the conventional optical pickup 50 shown in FIG. 10 has the following problems. FIGS. 11A and 11B are enlarged views of a soldering part of the wire 52. Herein, illustration of the retaining member 53 is omitted. FIG. 11A shows a condition where the lens holder 54 remains stationary, wherein the wire 52 maintains a linear condition. At this time, a fixing point of the wire 52 is at a point B of the soldering portion 56. FIG. 11B shows a condition where the lens holder 54 has shifted in the upper direction in terms of FIG. 10. In this condition, in a manner following the shift of the lens holder 54, the wire 52 is displaced as shown by 52′. At this time, the inside diameter of the through hole 51a formed on the substrate 51 is greater than the outside diameter of the wire 52, and the wire 52 is inserted through the through hole 51a so that there is play therebetween, therefore, when the wire 52 is displaced as illustrated, the fixing point is shifted from point B of the soldering portion 56 to a point C of an edge portion of the through hole 51a. Namely, the fixing point of the wire 52 is changed as a result of a shift of the lens holder 54. When the fixing point is changed as such, damping characteristics are changed since the movable length of the wire 52 is changed, thus causing undesirable results such as an unstable sensitivity.

Moreover, the conventional optical pickup also has a problem such that there is a limit in heightening resonance frequency of the wire 52. That is, generally in an optical pickup, when a disk is driven at a high x speed, it is necessary to improve the sensitivity so that the optical pickup can follow the disk rotation at a high speed, and for this, it is required to set the resonance frequency of the wire 52 high so as to prevent the wire 52 from producing an unnecessary vibration. As this method for heightening resonance frequency, thickening the wire 52 in diameter can be considered, however, by this method, the wire 52 is increased in cost. Accordingly, by shortening the distance between the fixing points of the wire 52, the resonance frequency can be heightened without an increase in cost. Notwithstanding, in the optical pickup of FIG. 10, since the soldering portion 56 of the wire 52 exists at the surface 51b of the substrate 51 on the side opposite the lens holder 54 side, the distance between the base end-side fixing point (soldering portion 56) and front end-side fixing point (convex portion 54a) of the wire 52 is long, and a limit exists in heightening the resonance frequency. As a result, the wire 52 sympathetically vibrates at the time of high x speed driving of a disk to lower the tracking ability of the optical pickup, whereby optical reading accuracy for the disk is likely to be deteriorated.

The foregoing is the same in Patent documents 1 and 2. Moreover, in Patent document 3, although a structure wherein a wire and a substrate are soldered at a lens holder-side surface of the substrate has been disclosed, no cushioning material is provided in the optical pickup of this patent document, therefore, when the wire sympathetically vibrates, this vibration cannot be absorbed, thus the tracking ability of the optical pickup is lowered. Furthermore, since this is not a structure where the wires penetrate through the substrate, a problem exists such that, when soldering the wires to the substrate, wire positioning is extremely difficult and productivity is inferior.

### SUMMARY OF THE INVENTION

The present invention is made for solving the above-described problems, and an object thereof is to provide an optical pickup which has stable damping characteristics, which is excellent in tracking ability at the time of high x speed driving, and which is easy to manufacture.

An optical pickup of the present invention is provided with: a substrate; a plurality of wires whose base end sides are fixed to this substrate; a lens holder which is supported on the front end sides of these wires and which holds an object lens and a plurality of drive coils; and a retaining member which is provided between the substrate and which retains a cushioning material for absorbing vibration of the wires and in which the substrate and retaining member form a stationary block while the lens holder forms a movable block, the wires are made of resilient metal materials and are electrically connected to drive coils, and the lens holder is shifted in predetermined directions based on a power distribution to the drive coils, wherein the retaining member has spatial portions for filling a cushioning material, a plurality of through holes are formed on the substrate, and through these through holes, the base end sides of the wires are respectively inserted. In addition, the wires are disposed so as to be stored in the spatial portions of the retaining member and are, at a lens holder-side surface of the substrate, soldered to the substrate.

In the present invention, since the wires are inserted through the through holes of the substrate and are fixed by soldering at the lens holder-side surface of the substrate, even when the lens holder is shifted during focus control and tracking control, etc., the fixing points of the wires are always at the soldering portions, and the fixing points are never changed. Accordingly, there is no such case where damping characteristics are changed by a change in the fixing points, and stable characteristics can be maintained. In addition thereto, since the base end-side fixing point of the wire can further be approximated to the lens holder-side fixing point, the distance between the fixing points can be shortened and the resonance frequency can be set higher, whereby it becomes possible to respond to the time of high x speed driving of a disk where a high sensitivity is required. Furthermore, since the wires can be soldered in a manner inserted through the through holes of the substrate, wire positioning can be simply carried out when the wires are soldiered to the substrate, and manufacturing can also be easily carried out.

The spatial portions for filling a cushioning material provided in the retaining member may be concave portions formed so as to be laterally opened or may be hollow portions whose peripheries are blocked. In a case of the laterally opened concave portions, the cushioning material can be laterally filled, thus workability is improved. On the other hand, in a case of the hollow portions whose peripheries are blocked, the cushioning material can be filled in a sealing condition, thus an external outflow can be prevented.

In the present invention, by making it possible, in a condition where the substrate and retaining material are fixed, to form a gap between the substrate and retaining member, even in a case where soldering between the wires and substrate is carried out after the substrate and retaining member are fixed, the wires can be laterally soldered through the gap, therefore, without being hindered by the retaining member, the soldering work can be easily carried out. As an embodiment of this case, it is preferable to provide notch portions to communicate with the concave portions on a side of the retaining member opposed to the substrate so that, in a condition where the substrate and retaining material are fixed, a gap is formed therebetween by the notch portions.

In addition, as another embodiment, it may also be possible, in a condition where the substrate and retaining member are fixed, to communicate the concave portions of the retaining member with the through holes of the substrate so that the wires can be laterally soldered through the concave portions. According to this structure, it is unnecessary to fix the retaining member apart from the substrate and the retaining member can be fixed being adjacent to the substrate, therefore, the displacement amount of the wires can be secured.

According to the present invention, since the fixing points of the wires are not changed even when the lens holder is shifted, damping characteristics are never changed, thus stable characteristics can be maintained. Moreover, since the base end-side fixing point of the wire can further be approximated to the lens holder-side fixing point so that the resonance frequency can be set higher, it becomes possible to respond to the time of high x speed driving of a disk where a high sensitivity is required. Furthermore, since the wires can be soldered in a manner inserted through the through holes of the substrate, positioning of the wires at the time of soldering can be simply carried out, and manufacturing can also be easily carried out.

### BRIEF DESCRIPTION OF THE DRAWINGS

These and other objects and advantages of this invention will become more fully apparent from the following detailed description taken with the accompanying drawings in which:

FIG. 1 is a top view of an optical pickup according to an embodiment of the invention;

FIG. 2 is a right side view of the same optical pickup;

FIGS. 3A and 3B are sectional views of the same optical pickup;

FIG. 4 is a side sectional view showing a detailed structure of the main part of the same optical pickup;

FIGS. 5A and 5B are views of an enlarged wire soldering part;

FIG. 6 is a side sectional view of an optical pickup according to another embodiment of the invention;

FIG. 7 is a front sectional view showing another embodiment of a gel box;

FIG. 8 is a side sectional view of an optical pickup according to another embodiment of the invention;

FIG. 9 is a front sectional view showing another embodiment of a gel box;

FIG. 10 is a side sectional view of a conventional optical pickup;

FIGS. 11A and 11B are enlarged views of a wire soldering part in the prior art.

### DETAILED DESCRIPTION OF THE PREFERRED EMBODIMENTS

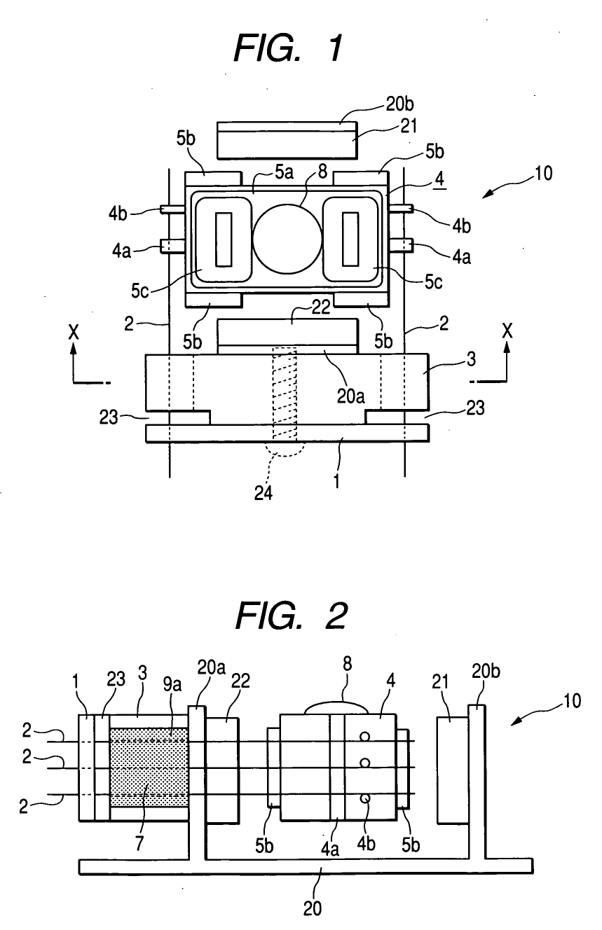

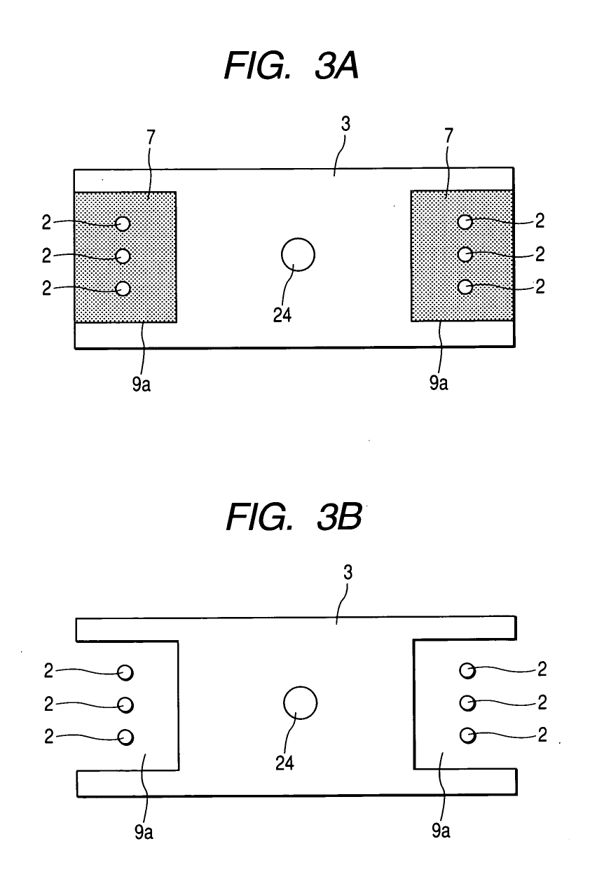

FIG. 1 through FIGS. 3A and 3B are views showing an example of an optical pickup according to the present invention, wherein FIG. 1 is a top view, FIG. 2 is a right side view, and FIGS. 3A and 3B are sectional views a long X-X of FIG. 1. In the drawings, 10 denotes an optical pickup used for a DVD player or the like, which is provided with a substrate 1, a plurality of wires 2, a gel box (retaining member) 3, and a lens holder 4. The substrate 1 and gel box 3 form a stationary block, which is attached, via a screw 24 (FIG. 1) of a fixing material, to a support wall 20a arranged in a standing condition on a base 20 (FIG. 2). Here, as the fixing member, in addition to a screw, a hook piece and an adhesive, etc., can be used. The lens holder 4 forms a movable block, which is supported on the front end sides of the wires 2 fixed to the substrate 1. Details of a fixing structure of the wires 2 on the substrate 1 will be described later.

The gel box 3 has, as shown in FIG. 2, concave portions 9a for filling a cushioning material and has, on the side opposed to the substrate 1, notch portions 23 to communicate with the concave portions 9a. A cushioning material 7 made of viscoelastic media (for example, a silicon-based gel agent) for absorbing vibration of the wires 2 is filled in the concave portions 9a. FIG. 3A shows a condition where the cushioning material 7 has been filled, and FIG. 3B shows a condition before the cushioning material 7 is filled. As in FIG. 3B, the concave portion 9a is formed on both sides of the gel box 3 in a manner laterally opened (in the right and left directions of the drawing). In addition, three wires 2 are formed each right and left across the gel box 3 and are disposed so as to be stored in the respective concave portions 9a, and as in FIG. 3A, the wires penetrate through the cushioning material 7 filled in the concave portion 9a.

The lens holder 4 holds the object lens 8 and is provided with three types of drive coils composed of a focus coil 5a for shifting the lens holder 4 in the vertical direction with respect to the disk, tracking coils 5b for shifting the lens holder 4 in the horizontal direction with respect to the disk, and tilt coils 5c for shifting the lens holder 4 in the diagonal direction with respect to the disk. In addition, on the side surface of the lens holder 4, a convex portion 4a with which the wires 2 are engaged and pins 4b around which end portions of the respective coils 5a, 5b, and 5c are wound are provided. 21 denotes a magnet fixed to a support wall 20b provided in a standing condition on a base 20, 22 denotes a magnet fixed to a support wall 20a, and by a Lorenz force acting between magnetic fields generated by a power distribution to the respective coils 5a, 5b, and 5c and magnetic fields of the magnets 21 and 22, the lens holder 4 is shifted in predetermined directions. Vibration produced by the wires 2 during this shifting is absorbed by the cushioning material 7 of the gel box 3.

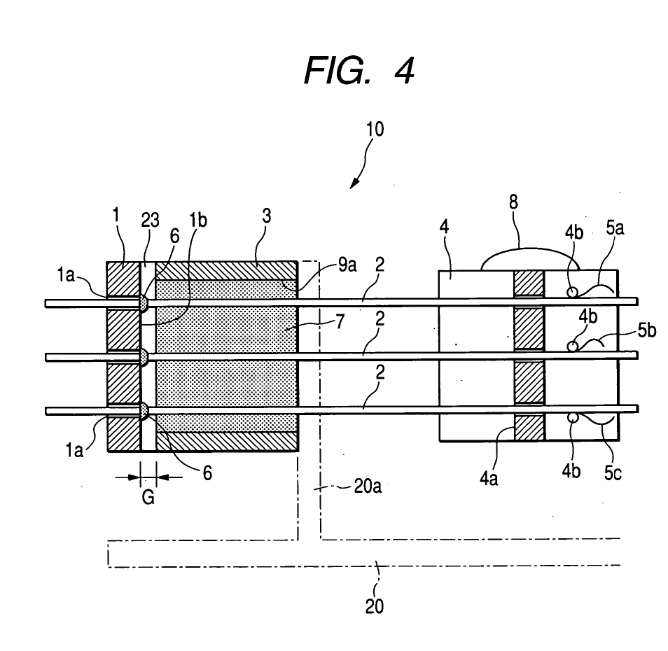

FIG. 4 is a side sectional view showing a detailed structure of the main part of the optical pickup 10. Herein, illustration of the tracking coil 5b and magnet 22 of FIG. 2 is omitted. On the substrate 1, a plurality of through holes 1a are formed, and through these through holes 1a, the base end sides of wires 2 are respectively inserted. The wires 2 are made of conductive resilient metal materials such as, for example, phosphor bronze or beryllium copper, and by being soldered at a surface 1b of the substrate 1 on the lens holder 4 side, the wires 2 are fixed to the substrate 1. 6 denotes this soldering portion. Here, around the through hole 1a of the surface 1b, a copper foil portion (illustration is omitted) for soldering is formed. As can be understood from FIG. 4, in a condition where the substrate 1 and gel box 3 are fixed, a gap G is formed therebetween by the notch portions 23. With the convex portion 4a of the lens holder 4, the front end sides of the wires 2 are engaged, and around the plurality of pins 4b provided on the side surface of the lens holder 4, end portions of the aforementioned respective coils 5a, 5b, and 5c are wound. The pins 4b are provided in proximity to the wires 2, and end portions of the coils 5a, 5b, and 5c wound around the pins 4b are electrically connected to the wires 2 by a means such as soldering.

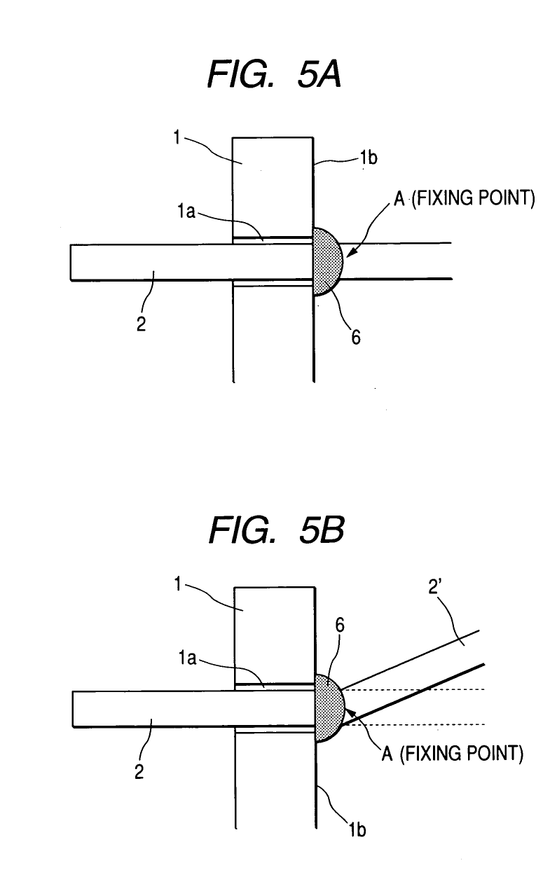

FIGS. 5A and 5B are views of an enlarged soldering part of the wire 2. Herein, illustration of the gel box 3 is omitted. FIG. 5A shows a condition where the lens holder 4 remains stationary, wherein the wire 2 maintains a linear condition. At this time, a fixing point of the wire 2 is at a point A of the soldering portion 6. FIG. 5B shows a condition where the lens holder 4 has shifted in the upper direction in FIG. 4. In this condition, in a manner following the shift of the lens holder 4, the wire 2 is displaced as shown by 2′. In this case, notwithstanding that the inside diameter of the through hole 1a formed on the substrate 1 is greater than the outside diameter of the wire 2 and the wire 2 has been inserted through the through hole 2 so that there has been play therebetween, the fixing point is point A, which is the same as the fixing point before the displacement. Namely, even when the lens holder 4 is shifted, since the fixing point of the wire 2 is not changed, damping characteristics are never changed, thus stable characteristics can be maintained.

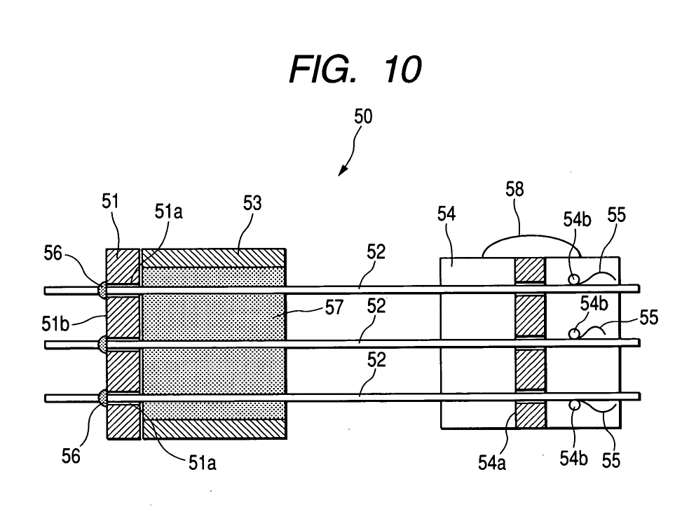

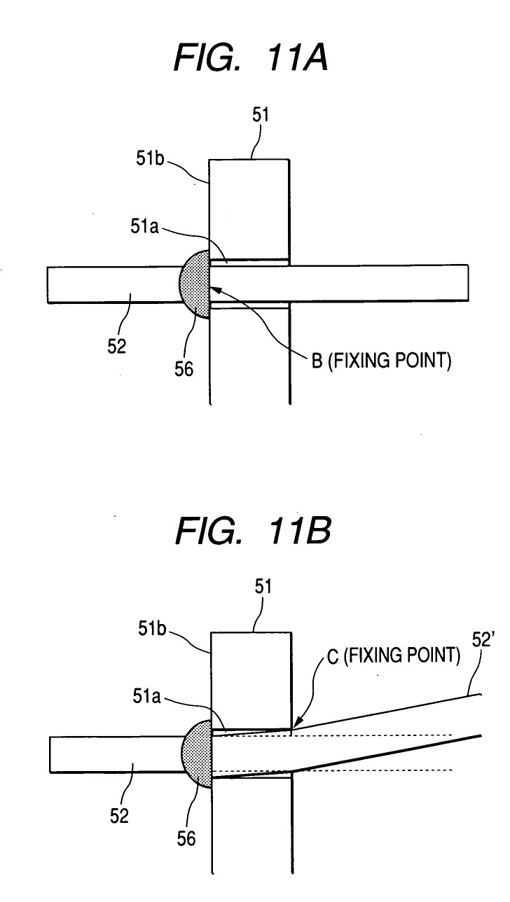

In the optical pickup shown in FIG. 4, in comparison with the prior art of FIG. 10, the base end-side fixing point (soldering portion 6) of the wire 2 can be approximated to the lens holder 4-side fixing point (protruded portion 4a) by a thickness of the substrate 1. As a result, the distance between the fixing points is shortened, the resonance frequency of the wire 2 can be set higher, whereby making it possible to respond to the time of high x speed driving of a disk where a high sensitivity is required. Furthermore, since the wires 2 can be soldered in a manner inserted through the through holes 1a of the substrate 1, positioning of the wires 2 can be simply carried out when the wires 2 are soldered to the substrate 2, and manufacturing can also be easily carried out.

In addition, in the embodiment, as described above, since a gap G (FIG. 4) is formed between the substrate 1 and gel box 3 by the notch portions 23, when the wires 2 and substrate 1 are soldered in a condition where the substrate 1 and gel box 3 have been fixed to the support wall 20a, soldering can be laterally carried out through the gap G. Therefore, without being hindered by the gel box 3, the soldering work can be easily carried out. Furthermore, since the concave portions 9a of the gel box 3 are laterally opened, an operation for filling the cushioning material 7 in the concave portions 9a can also be laterally carried out, thus workability is improved. Here, the cushioning material 7 may be filled in the concave portions 9a before soldering the wires 2 and substrate 1, or may be filled in the concave portions 9a after the soldering between the wires 2 and substrate 1 is completed. In the latter case, since the gap G and concave portion 9a are communicated and laterally opened at the time of soldering, the soldering operation can further be easily carried out.

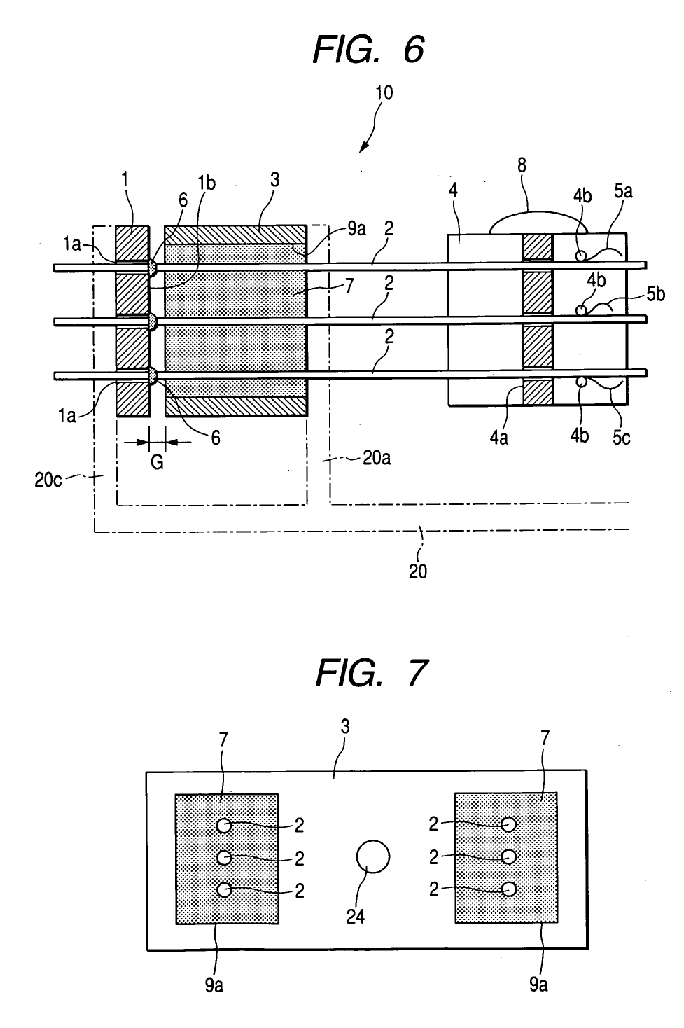

Moreover, in the embodiment, although the substrate 1 and box 3 are fixed to the support wall 20a by the screw 24, it may also be possible, as shown in FIG. 6, to attach the substrate 1 to a support wall 20c provided in a standing condition on the base 20 by a screw or the like and attach the gel box 3 to a support wall 20a provided in a standing condition on the base 20 by a screw or the like. In this case, it is unnecessary to provide the above-described notch portions 23 on the gel box 3. In addition, the distance between the support wall 20a and support wall 20c is set so that a gap G is formed between the substrate 1 and gel box 3. Since the embodiment of FIG. 6 is the same as the embodiment of FIG. 4 except for the above point, identical symbols are used for parts identical to those of FIG. 4.

In addition, in the above embodiments, as the spatial portions of the gel box 3 for filling a cushioning material, the laterally opened concave portions 9a have been mentioned as an example, however, in place thereof, as shown in FIG. 7, hollow portions 9b whose peripheries are blocked can be employed as cushioning material filling spatial portions. In FIG. 7, identical symbols are used for parts identical to those of FIG. 3. According to the gel box 3 of FIG. 7, since the peripheries of the hollow portions 9b are blocked, the cushioning material 7 can be filled in a sealing condition in the hollow portions 9b, therefore, even when the cushioning material 7 has fluidity, an external outflow of the filled cushioning material 7 can be prevented.

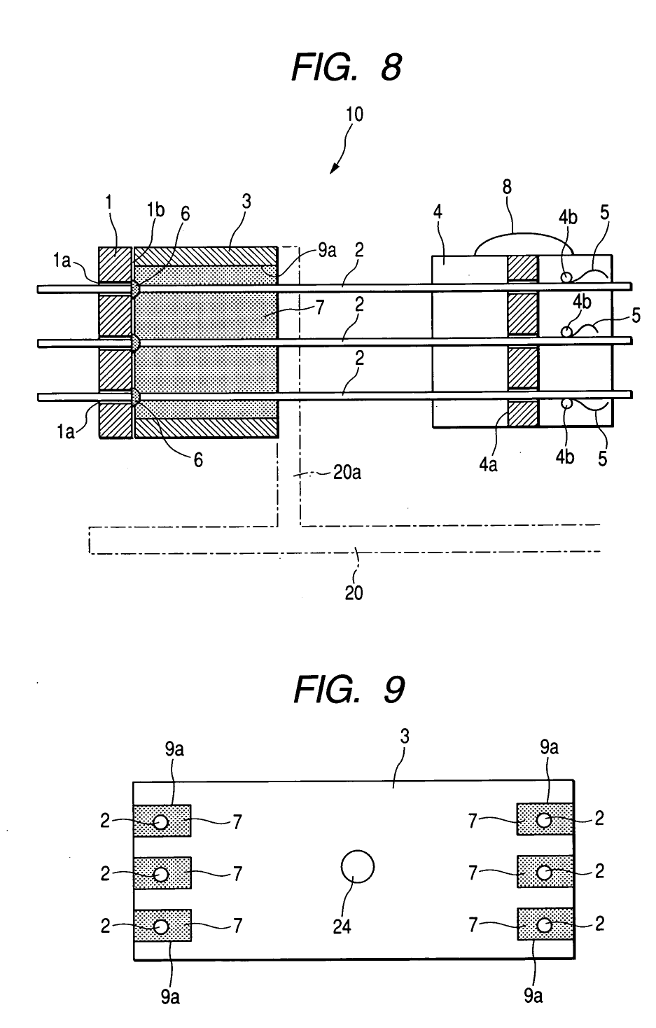

FIG. 8 shows another embodiment of the present invention. In this embodiment, as the gel box 3, a gel box wherein concave portions 9a are laterally opened as in FIG. 3 is used. In FIG. 8, the difference from FIG. 4 is in that no notch portions 23 are provided for the gel box 3 and, in a condition where the substrate 1 and gel box 3 are fixed, no gap G exists therebetween. Namely, in the present embodiment, the substrate 1 and gel box 3 have been fixed in a closely fitted condition, and in this condition, the concave portions 9a of the gel box 3 are communicated with the through holes 1a of the substrate 1. Since other aspects are identical to those of the embodiment of FIG. 4, identical symbols are used for parts identical to those of FIG. 4.

In the embodiment of FIG. 8 as well, since the soldering portion 6 between the wire 2 and substrate 1 exists on the lens holder side, as has been described in terms of FIGS. 5A and 5B, the fixing point of the wire 2 is not changed even when the lens holder 4 is shifted, thus stable damping characteristics can be maintained. In addition, since the distance between the fixing points of the wire 2 is shortened and the resonance frequency can be set higher, it becomes possible to respond to the time of high x speed driving of a disk where a high sensitivity is required. Furthermore, since the wires 2 can be soldered in a manner inserted through the through holes 1a of the substrate 1, positioning of the wires 2 can be simply carried out when the wires 2 are soldered to the substrate 1, and manufacturing can also be easily carried out.

In addition, in the case of FIG. 8, since no gap exists between the substrate 1 and gel box 3, it is necessary to fill the cushioning material 7 in the concave portions 9a after soldering between the wire 2 and substrate 1 is completed, however, in this case as well, since the concave portions 9a are laterally opened and the concave portions 9a and through holes 1a of the substrate 1 are communicated, soldering of the wires 2 can be laterally carried out through the concave portions 9a. Accordingly, without being hindered by the gel box 3, the soldering work can be easily carried out.

Then, after soldering of the wires 2 to the substrate 1 is finished, the cushioning material 7 is filled in the concave portions 9a. In this case, since the concave portions 9a are laterally opened, the filling work of the cushioning material 7 can be laterally carried out, thus workability is improved. In addition, since the through holes 1a of the substrate 1 are blocked by the soldering portions 6, even when the cushioning material 7 has fluidity, the cushioning material 7 is, when being filled, prevented from intruding into the through holes 1a. Furthermore, according to the present invention, it is unnecessary to fix the gel box 3 apart from the substrate 1 and the gel box 3 can be fixed in a manner closely fitted to the substrate 1, the length of protruding parts of the wires 2 from the gel box 3 is lengthened, thus the displacement amount of the wires 2 can be secured.

In the above-described embodiments, an optical pickup 10 provided with, as drive coils, three types of coils 5a, 5b, and 5c for focusing, for tracking, and for tilting has been mentioned as an example, however, the present invention is not limited hereto, the drive coils can be of, for example, two types composed of a focus coil 5a and tracking coils 5b.

In addition, in the above embodiments, an example where three wires 2 are stored in the single concave portion 9a has been shown, however, as in FIG. 9, concave portions 9a for storing the respective wires 2 may be individually provided and the cushioning material 7 may be filled in the respective concave portions 9a.

In addition, in the above embodiments, an example where three wires 2 are disposed each right and left of the gel box 3 has been shown, however, the present invention is not limited hereto, and for example, two wires 2 may be disposed each in right and left of the gel box 3.

1. An optical pickup comprising:
a substrate;
a plurality of wires whose base end sides are fixed to this substrate;
a lens holder which is supported on the front end sides of these wires and which holds an object lens and a plurality of drive coils; and
a retaining member which is provided between the substrate and which retains a cushioning material made of viscoelastic media for absorbing vibration of the wires, and in which the substrate and retaining member form a stationary block while the lens holder forms a movable block, the wires are made of resilient metal materials and are electrically connected to drive coils, and the lens holder is shifted in predetermined directions based on a power distribution to the drive coils, wherein:
the retaining member has laterally opened concave portions for filling a cushioning material and has, on its side opposed to the substrate, notch portions to communicate with the concave portions;
a plurality of through holes are formed on the substrate, and through these through holes, the base end sides of the wires are respectively inserted;
the wires are disposed so as to be stored in the concave portions of the retaining member and are, at a lens holder-side surface of the substrate, soldered to the substrate; and
the substrate and retaining member are fixed by a fixing member and are structured so that, in a condition where both are fixed, a gap is formed between the substrate and retaining member by the notch portions, and wire soldering can be laterally carried out through this gap.

2. An optical pickup comprising:
a substrate;
a plurality of wires whose base end sides are fixed to this substrate;
a lens holder which is supported on the front end sides of these wires and which holds an object lens and a plurality of drive coils; and
a retaining member which is provided between the substrate and which retains a cushioning material made of viscoelastic media for absorbing vibration of the wires, and in which the substrate and retaining member form a stationary block while the lens holder forms a movable block, the wires are made of resilient metal materials and are electrically connected to drive coils, and the lens holder is shiftedi np redetermined directions based on a power distribution to the drive coils, wherein:
the retaining member has laterally opened concave portions for filling a cushioning material;
a plurality of through holes are formed on the substrate, and through these through holes, the base end sides of the wires are respectively inserted;
the wires are disposed so as to be stored in the concave portions of the retaining member and are, at a lens holder-side surface of the substrate, soldered to the substrate; and
the substrate and retaining member are fixed by a fixing member and are structured so that, in a condition where both are fixed, the concave portions of the retaining member and through holes of the substrate are communicated, and wire soldering can be laterally carried out through the concave portions.

3. An optical pickup comprising:
a substrate;
a plurality of wires whose base end sides are fixed to this substrate;
a lens holder which is supported on the front end sides of these wires and which holds an object lens and a plurality of drive coils; and
a retaining member which is provided between the substrate and which retains a cushioning material for absorbing vibration of the wires, and in which the substrate and retaining member form a stationary block while the lens holder forms a movable block, the wires are made of resilient metal materials and are electrically connected to drive coils, and the lens holder is shifted in predetermined directions based on a power distribution to the drive coils, wherein:
the retaining member has spatial portions for filling a cushioning material;
a plurality of through holes are formed on the substrate, and through these through holes, the base end sides of the wires are respectively inserted; and
the wires are disposed so as to be stored in the spatial portions of the retaining member and are, at a lens holder-side surface of the substrate, soldered to the substrate.

4. The optical pickup according to claim 3, wherein
the spatial portions of the retaining member are concave portions formed so as to be laterally opened.

5. The optical pickup according to claim 3, wherein
the spatial portions of the retaining member are hollow portions whose surroundings are blocked.

6. The optical pickup according to claim 4, wherein
in a condition where the substrate and retaining member are fixed, a gap is formed between the substrate and retaining member, and wire soldering can be laterally carried out through the gap.

7. The optical pickup as set forth in claim 4, wherein
in a condition where the substrate and retaining member are fixed, the concave portions of the retaining member and through holes of the substrate are communicated, and wire soldering can be laterally carried out through the concave portions.
